(19) United States
(12) Patent Application Publication
(10) Pub. No.: US 2025/0042001 A1
(43) Pub. Date: Feb. 6, 2025

(54) Micro-action Ratchet Wrench

(71) Applicant: Kai, Zhangjiagang City (CN)

(72) Inventors: CHIA-HSUAN LEE, Changhua City (TW); Kai Zhang, Zhangjiagang City (CN)

(21) Appl. No.: 18/230,186

(22) Filed: Aug. 4, 2023

(51) Int. Cl. B25B 13/46; B25B 13/48

(52) U.S. Cl. CPC B25B 13/463; B25B 13/481

(57) ABSTRACT

The present invention provides a micro-action ratchet wrench. a wrench has a main hole arranged thereon and a first and a second arc surfaces recessed in the wall surface of the main hole for correspondingly forming the first and second chambers, so that the centerlines of the first and second chambers intersect with the center of the main hole to maintain a set angle. The main hole is coupled with a ratchet. The ratchet has an outer connection portion and an outer teeth portion. The first and second chambers are correspondingly equipped with the first and second detents and the first and second springs. The first and second detents are provided with pawls, the first and second springs actuate the corresponding first and second detents, so that the pawls of the first and second detents can differentially engage the outer teeth portion of the ratchet through the set angle configuration.

### BACKGROUND OF THE PRESENT INVENTION

### Field of Invention

The present invention refers specifically to a micro-motion ratchet wrench that can operate in a narrow environment. The core technology is that: (A) controlling a set angle between the first and second chambers to provide the first and second detents differentially engage the outer teeth portion of the ratchet, thereby reducing the force angle of the wrench by half when changing teeth. (B) When the wrench uses any detent to apply force or empty return to the ratchet, the other detent is controlled to be suspended without force, so as to improve the smoothness of the overall operation.

### Description of Related Arts

The ratchet inside the ratchet wrench, based on the structural strength requirements, the number of ratchet teeth is at most 72 teeth. When 360° is divided by 72 teeth, it is known that the force application angle of each tooth and tooth change of the ratchet is 5°. Among them, the force angle of 5° tooth change is used in a narrow environment operation, which is indeed insufficient. For this reason, some people in the industry have developed a ratchet wrench that can reduce the force angle of changing teeth by half.

As shown in the CN202020672415.4 “Ratchet Wrench” Chinese invention (US20210331295A1), a brake groove is provided on the body for installation of two side-by-side detents and a latch set. The two detents are respectively connected to the latch set through a reset piece to provide pre-pressure, so that the teeth of the two detents can be differentially engaged with the drive member (ratchet), so as to reduce the force application angle of changing teeth by half. However, the previous case has the following deficiencies:
1. Poor operability: the two detents and one latch set in the previous case, under the pre-pressure of the two reset parts, are at any time to abut against the wall of the brake groove. When one detent is applying force or emptying back to the drive member, because the other detent has no active gap with the wall of the brake groove, a pre-pressure is provided to intervene in the driving part, which causes the body to get stuck during the process of switching force or returning.
2. Laborious assembly: the assembly of the previous case needs to exert enough force through the fingers of one hand to sandwich the two detents and the latch set laterally, so as to compress the two reset parts, so that the spacing between the two detents and the latch set can be pressed down into the brake groove, and then the drive member is rotated and inserted into the drive aperture by the other hand, and then it is completed by passing through the teeth of the two detents sequentially, and its overall assembly is very laborious, and the slight lack of strength will fall short, resulting in the overall assembly efficiency being difficult to improve.
3. Manufacture does not conform to economic benefits: the previous case reduced one brake groove, but added one latch set, which is difficult to reduce manufacturing costs. More importantly, the height of the brake groove for installing two parallel detents needs to be doubled. Therefore, the T-shaped tool for processing the brake groove needs to use special specifications or use general specifications for multiple cutting, which does increase tool costs or significantly increase production time.

### SUMMARY OF THE PRESENT INVENTION

The main purpose of the present invention is to provide a micro-action ratchet wrench that can completely solve the shortcomings of the previous case, which has the advantages of easy assembly, economical manufacture and smooth operation of the wrench, which at least includes:
a wrench, having a main hole arranged thereon and a first arc surface and a second arc surface, respectively, recessed in the wall surface of the main hole to form a first chamber and a second chamber corresponding to the main hole, wherein a first centerline of the first chamber and a second centerline of the second chamber intersect at a center of the main hole to maintain a set angle;
a ratchet, having an outer connection portion penetrated through the center thereof and an outer teeth portion that is coupled to the main hole and is provided with n teeth surrounded the outer circumference thereof, wherein the set angle is defined as 360° divided by n, then divided by 2, and finally multiplied by an odd integer greater than 1;
two detents, each having pawls capable of engaging the outer teeth portion of the ratchet, wherein a first detent is installed in the first chamber and the second detent is installed in the second chamber; and
two springs, defined as a first spring installed in the first chamber and a second spring installed in the second chamber, are used to actuate the corresponding first detent and the second detent, so that the first detent and the second detent are capable of differentially engaging the outer teeth portion of the ratchet through the set angle configuration, reducing the force application angle of the wrench by half when changing teeth, wherein when the wrench applies force with any detent or empty return to the ratchet, the other detent is controlled to be in a suspended state without force.

### BRIEF DESCRIPTION OF THE DRAWINGS

FIG. 1 is an exploded view of the present invention.

FIGS. 2A and 2B are sectional views of the wrench of the present invention to illustrate the relative positions of the set angles.

FIG. 3 is a partially assembled perspective view of FIG. 1.

FIG. 4 is an assembled perspective view of FIG. 1.

FIG. 5 is a longitudinal sectional view of FIG. 4.

FIG. 6A is a sectional view of A-A in FIG. 5, which shows that when the wrench exerts force on the ratchet clockwise, the first detent is in the state of being jammed and stressed.

FIG. 6B is a sectional view of B-B in FIG. 5, which shows that when the first detent is in the state of being jammed and stressed, the second detent is in the state of suspension without force.

FIG. 7A is another sectional view of A-A in FIG. 5, which shows that when the wrench exerts force clockwise, the first detent is in the state of suspension without force.

FIG. 7B is another sectional view of B-B in FIG. 5, which shows that when the first detent is in the state of suspension without force, the second detent is in the state of being jammed and stressed.

FIG. 8A is another sectional view of A-A in FIG. 5, which shows that when the wrench is empty back counterclockwise, the first pawl is in a state of suspension without force.

FIG. 8B is another sectional view of B-B in FIG. 5, which shows that when the first detent is in the state of suspension and no force, the second detent is in the state of empty back and force.

### DETAILED DESCRIPTION OF THE PREFERRED EMBODIMENT

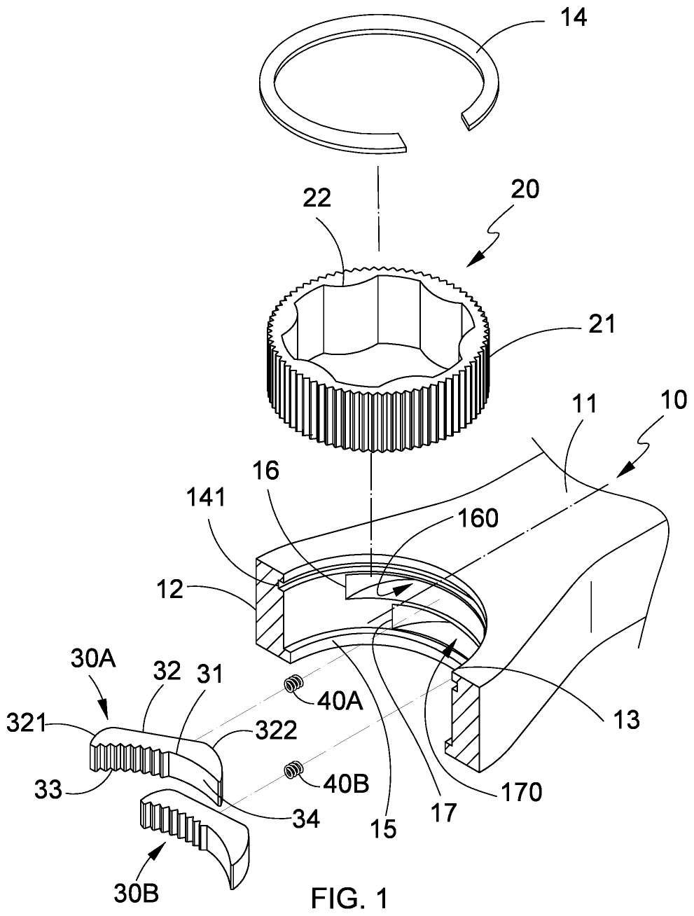

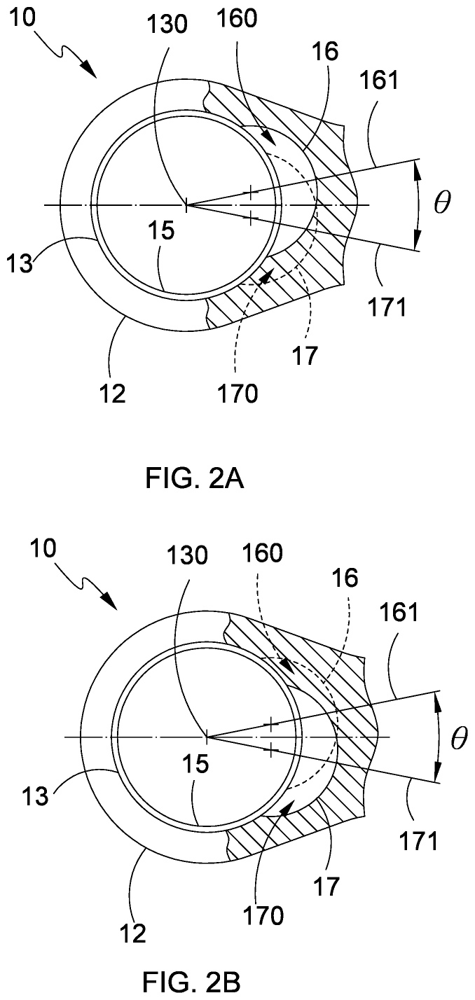

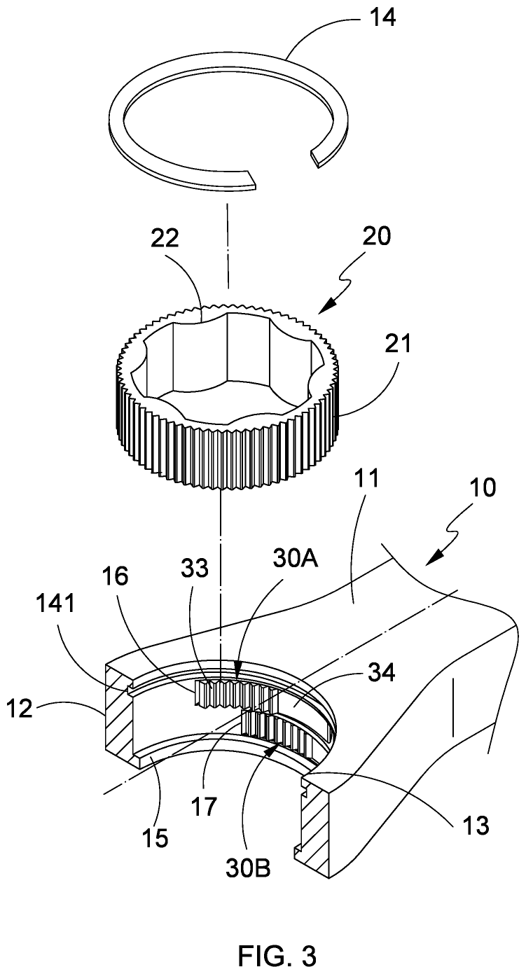

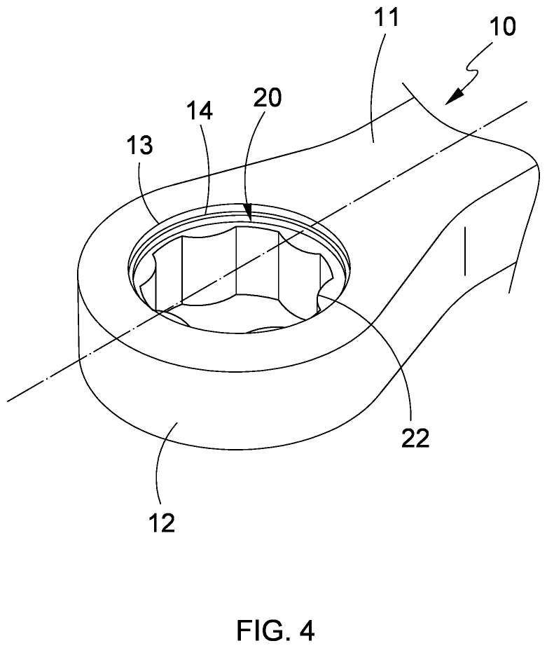

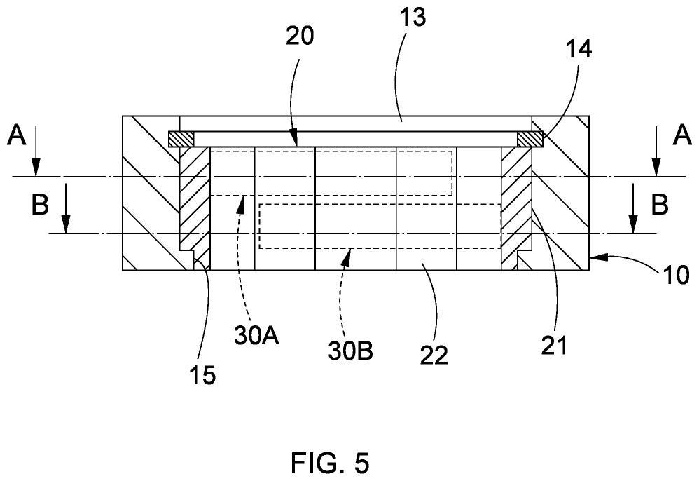

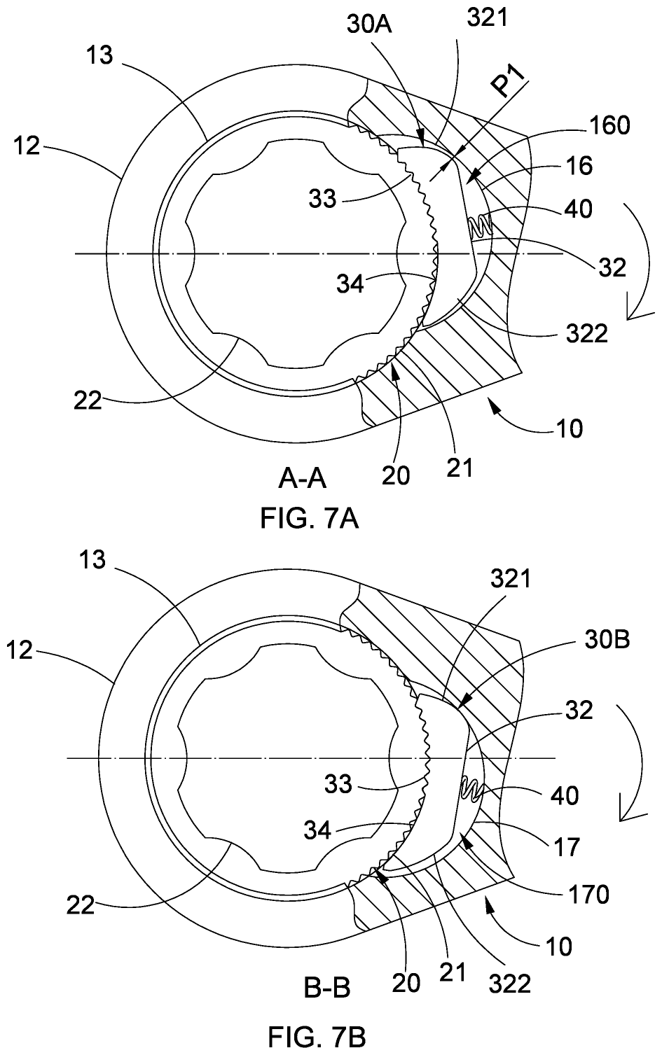

Referring to FIGS. 1 to 8B, a micro-action ratchet wrench of the present invention at least includes:
a wrench (10), which includes a rod body (11), a head seat (12) connected with one end of the rod body (11), a main hole (13) passing through the upper and lower surfaces of the head seat (12), a buckle groove (141) for installing a buckle ring (14) arranged on the top edge of the main hole (13), an inner flange (15) necked down the diameter and arranged on the bottom edge of the main hole (13), a first arc surface (16) and a second arc surface (17) arranged in the depression of the main hole (13) spaced at different heights towards the direction of the rod body (11), for correspondingly forming a first chamber (160) and a second chamber (170) connected to the main hole (13), wherein the shapes of the first chamber (160) and the second chamber (170) are symmetrical, so that the radii and radians of the first arc surface (16) and the second arc surface (17) are the same, as shown in FIGS. 2A and 2B, the first chamber (160) and the second chamber (170) maintain a set angle (θ), wherein the set angle (θ) is defined as the angle at which the first centerline (161) of the first chamber (160) and the second centerline (171) of the second chamber (170) intersect at the center (130) of the main hole (13), in particular, the first chamber (160) and the second chamber (170) are capable of being arranged on the wall surface of the main hole (13) at the same height;
a ratchet (20) coupled with the main hole (13), wherein the top surface thereof limited by the buckle ring (14) and the bottom surface thereof limited by the inner flange (15), so that the ratchet (20) is capable of rotating along the wall surface of the main hole (13); wherein the ratchet (20) has an outer teeth portion (21) with n teeth surrounded on the outer circumference thereof, and an outer connection portion (22) with a positive hexagonal hole concentrically penetrating through the ratchet (20), wherein the outer connection portion (22) is capable of being used for the matching of sleeves, bolts or nuts to perform the required loosening or tightening work; wherein the set angle (θ) is defined as 360° divided by n, then divided by 2, and finally multiplied by an odd integer greater than 1;
two detents (30A), (30B), wherein a first detent (30A) is installed in the first chamber (160), and a second detent (30B) is installed in the second chamber (170); wherein the two detents (30A), (30B) each have a front face (31) matching the peripheral curvature of the ratchet (20), and a back face (32) opposite to the front face (31), pawls (33) capable of engaging the outer teeth portion (21) of the ratchet (20) protrudes from the left half of the front face (31), and an escape zone (34) that does not mesh with the outer teeth portion (21) of the ratchet (20) is defined on the right half of the front face (31); wherein the back side (32) has a left curved surface (321) extending from the left end thereof, which connects to the left end of the pawls (33), and a right curved surface (322) extending from the right end thereof, which connects to the right end of the escape area (34); and
two springs (40A), (40B), wherein the first spring (40A) is installed in the first chamber (160), and the second spring (40B) is installed in the second chamber (170), wherein the first spring (40A) and the second spring (40B) actuate the corresponding first detent (30A) and the second detent (30B), so that the pawls (33) of the first detent (30A) and the second detent (30B) are capable of differentially engaging the outer teeth portion (21) of the ratchet (20) by the setting angle (θ) configuration, so as to reduce the force application angle of the wrench (10) by half when changing teeth, so that the wrench (10) can apply force to rotate the ratchet (20) in a narrow environment, thereby loosening or tightening the sleeve, bolt or nut; wherein one ends of the first spring (40A) and the second spring (40B) are positioned on the corresponding first arc surface (16) and second arc surface (17), and the other ends of the first spring (40A) and the second spring (40B) are abutted against the corresponding back face (32) of the first detent (30A) and the second detent (30B).

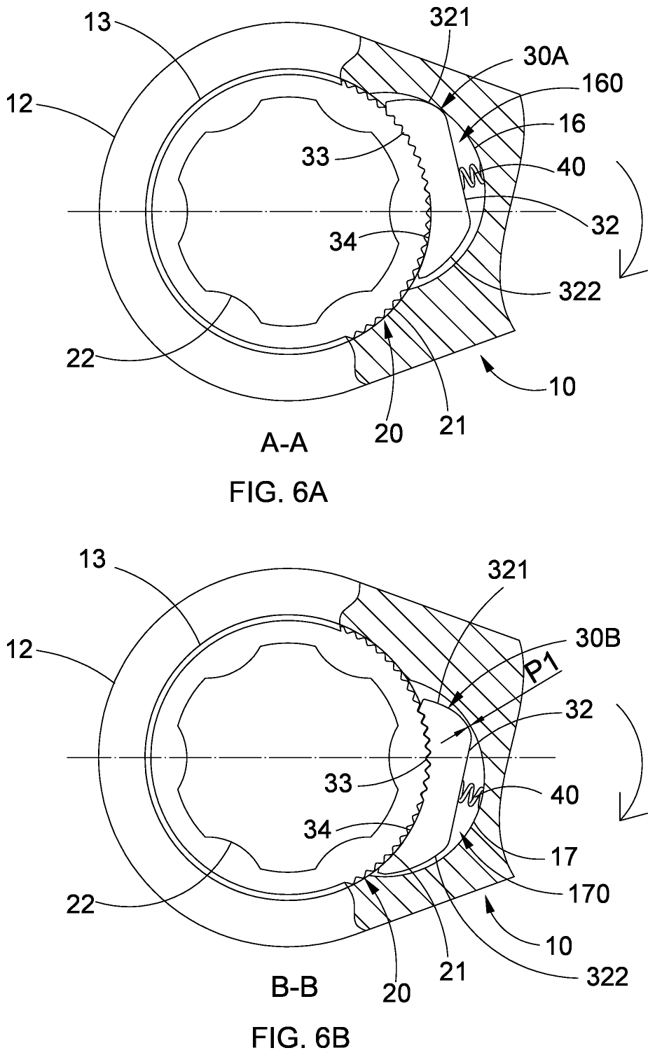

Referring to FIG. 6A, when the wrench (10) drives the first detent (30A) to engage the ratchet (20) and jam the left part of the first arc surface (16) to apply force clockwise to the ratchet (20), referring to FIG. 6B, the second detent (30B) will be pulled by the ratchet (20) to swing toward the left of the first arc surface (16). However, the present invention further controls to maintain a movable clearance (P1) between the second detent (30B) and the second arc surface (17), so that the second detent (30B) is suspended in the second chamber (170), does not directly bear the torque of the wrench (10), and only transmits the torque of the wrench (10) according to the first detent (30A). This structure can reduce the second detent (30B) from interfering with the ratchet (20) when the first detent (30A) is clutching the first arc surface (16), thereby providing better smooth operation. Since the shapes of the first detent (30A) and the second detent 30B correspond to each other, and a half-tooth differential locking ratchet (20) is formed by the setting angle, as shown in 7A and 7B, when the second detent (30B) is sequentially alternated and is engaged with the ratchet (20) and latched on the second arc surface (17) to transmit the clockwise torque of the wrench (10), there will also be a movable clearance (P1) between the first detent (30A) and the first arc surface (16), so that the first detent (30A) is suspended in the first chamber (160) without bearing the torque of the wrench (10).

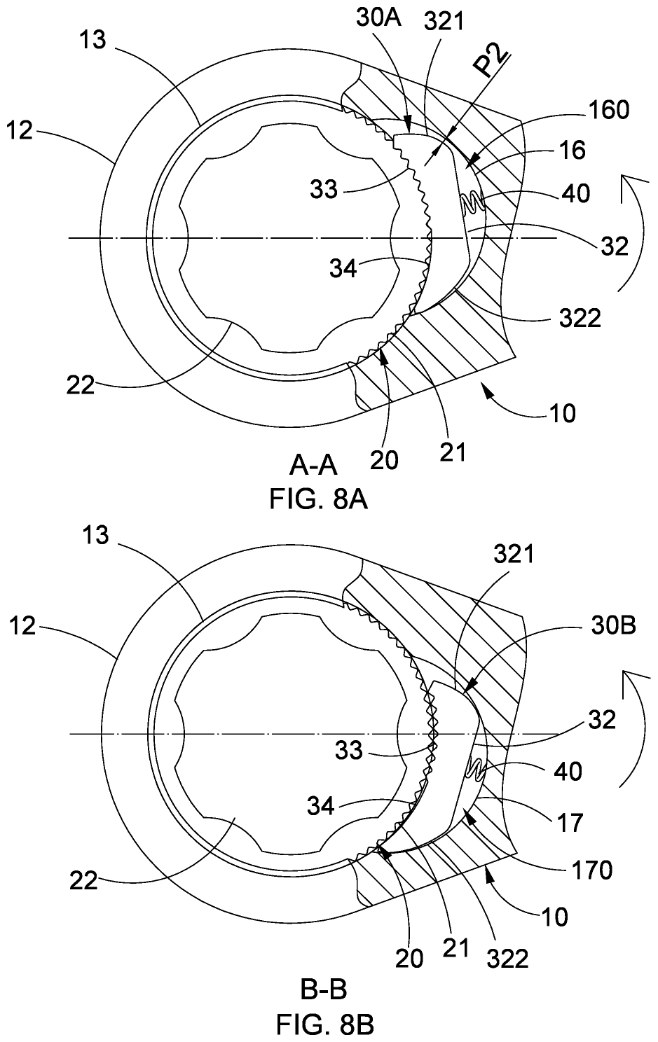

Referring to FIG. 8B, when the wrench (10) of the present invention intends to empty return counterclockwise to readjust the angle of the force application ratchet (20), the right curved surface (322) of the second detent (30B) acts on the second arc surface (17) to actuate the pawl (33) of the second detent (30B) to disengage from the ratchet (20), and controls the left curved surface (321) of the second detent (30B) not to touch the second arc surface (17). At the same time, as shown in FIG. 8A, the first detent (30A) is engaged with the ratchet (20), so that there is a large movable clearance (P2) between the left curved surface (321) of the first detent (30A) and the first arc surface (16), so as to provide enough space for subsequent the pawl (33) of the first detent (30A) to disengage from the ratchet (20). Therefore, the first detent (30A) is suspended in the first chamber (160), which does not directly bear the empty return torque of the wrench (10), and the wrench (10) only transmits the empty return torque according to the second detent (30B). This structural configuration effectively reduces the interference of the first detent (30A) with the ratchet (20) when the second detent (30B) is clutched with the second curved surface (17). Similarly, when the pawls (33) of the first detent (30A) disengage from the ratchet (20) and empty return in response to the wrench (10), the second detent (30B) is suspended in the second chamber (170), so that the second detent (30B) does not directly bear the empty return torque of the wrench (10), and the wrench (10) can smoothly perform the empty return operation.

The present invention has at least the following advantages:
1. The overall operation is smooth: the wrench (10) of the present invention controls another detent (30A) and (30B) to be suspended without force when applying force with any detent (30A) and (30B) or empty returning to the ratchet (20), so that the simultaneous interference of the two detents (30A) and (30B) with the ratchet (20) can be minimized, thereby effectively improving the problem of unsmooth jamming in the operation process of the previous case.
2. Effort-saving assembly: the present invention cooperates with gravity, and only needs to press down the two detents (30A) and (30B) with the fingers of one hand to easily overcome the two springs (40A) and (40B), and then install the ratchet (20) with the another hand to complete. This assembly technology is equivalent to the conventional double-detent ratchet wrench, and the technology is quite mature, which can greatly improve the laborious problem of the previous case, thus improving the overall assembly efficiency.
3. Economic benefits in manufacturing: the present invention does not need to increase the height of the first chamber (160) and the second chamber (170), so the first chamber (160) and the second chamber (170) can be easily processed only by using a T-shaped knife with general specifications to enter the main hole (13) first, and then using the indexing head of a milling machine or a comprehensive processing machine to control and the set angle (θ), which is more economical than the previous proposal.

The above is only one of the preferred embodiments of the present invention and should not be used to limit the implementation scope of the present invention; that is, all equivalent changes and modifications made according to the patent scope of the present invention belong to the present invention.

What is claimed is:

1. A micro-action ratchet wrench, which at least comprises:
a wrench, having a main hole arranged thereon and a first arc surface and a second arc surface, respectively, recessed in the wall surface of the main hole to form a first chamber and a second chamber corresponding to the main hole, wherein a first centerline of the first chamber and a second centerline of the second chamber intersect at a center of the main hole to maintain a set angle;
a ratchet, having an outer connection portion penetrated through the center thereof and an outer teeth portion that is coupled to the main hole and is provided with n teeth surrounded the outer circumference thereof, wherein the set angle is defined as 360° divided by n, then divided by 2, and finally multiplied by an odd integer greater than 1;
two detents, each having pawls capable of engaging the outer teeth portion of the ratchet, wherein a first detent is installed in the first chamber and the second detent is installed in the second chamber; and
two springs, defined as a first spring installed in the first chamber and a second spring installed in the second chamber, are used to actuate the corresponding first detent and the second detent, so that the pawls of the first detent and the second detent are capable of differentially engaging the outer teeth portion of the ratchet through the set angle configuration, reducing the force application angle of the wrench by half when changing teeth.

2. The micro-action ratchet wrench, as recited in claim 1, wherein when the wrench applies force or empty back to the ratchet with the first detent, controls the second detent and the second arc surface to maintain a movable clearance so that the second detent is suspended in the second chamber; when the wrench applies force or empty back to the ratchet with the second detent, controls the first detent and the first arc surface to maintain a movable clearance so that the first detent is suspended in the first chamber.

3. The micro-action ratchet wrench, as recited in claim 2, wherein the first detent and the second detent each have a front face matching the outer circumference of the ratchet, wherein the front face is protruded with pawls capable of engaging with the outer teeth portion of the ratchet, wherein the first detent and the second detent each have a back face opposite to the front face, wherein the back face has a left curved surface connected to the left end of the front face and extends from the left end thereof, and a right curved surface connected to the right end of the front face and extends from the right end thereof.

4. The micro-action ratchet wrench, as recited in claim 3, wherein the left half of the front face is protruded with pawls capable of engaging the outer teeth portion of the ratchet, wherein the right half of the front face is defined as an escape zone not engaged with the outer teeth portion of the ratchet.

5. The micro-action ratchet wrench, as recited in claim 1, wherein the shapes of the first chamber and the second chamber are symmetrical, so that the radius and radian of the first arc surface and the second arc surface are the same, wherein the shapes of the first detent and the second detent are symmetrical.

6. The micro-action ratchet wrench, as recited in claim 2, wherein the shapes of the first chamber and the second chamber are symmetrical, so that the radius and radian of the first arc surface and the second arc surface are the same, wherein the shapes of the first detent and the second detent are symmetrical.

7. The micro-action ratchet wrench, as recited in claim 3, wherein the shapes of the first chamber and the second chamber are symmetrical, so that the radius and radian of the first arc surface and the second arc surface are the same, wherein the shapes of the first detent and the second detent are symmetrical.

8. The micro-action ratchet wrench, as recited in claim 4, wherein the shapes of the first chamber and the second chamber are symmetrical, so that the radius and radian of the first arc surface and the second arc surface are the same, wherein the shapes of the first detent and the second detent are symmetrical.

9. The micro-action ratchet wrench, as recited in claim 1, wherein the wall surface of the main hole is recessed with the first arc surface and the second arc surface at different heights.

10. The micro-action ratchet wrench, as recited in claim 2, wherein the wall surface of the main hole is recessed with the first arc surface and the second arc surface at different heights.

11. The micro-action ratchet wrench, as recited in claim 3, wherein the wall surface of the main hole is recessed with the first arc surface and the second arc surface at different heights.

12. The micro-action ratchet wrench, as recited in claim 4, wherein the wall surface of the main hole is recessed with the first arc surface and the second arc surface at different heights.

13. The micro-action ratchet wrench, as recited in claim 1, wherein the main hole is recessed with the first arc surface and the second arc surface at the same height.

14. The micro-action ratchet wrench, as recited in claim 2, wherein the main hole is recessed with the first arc surface and the second arc surface at the same height.

15. The micro-action ratchet wrench, as recited in claim 3, wherein the main hole is recessed with the first arc surface and the second arc surface at the same height.

16. The micro-action ratchet wrench, as recited in claim 4, wherein the main hole is recessed with the first arc surface and the second arc surface at the same height.

17. The micro-action ratchet wrench, as recited in claim 1, wherein the wrench comprises a buckle groove arranged on the main hole for installing a buckle ring, and an inner flange arranged on the main hole and necked down the diameter thereof, wherein the ratchet is restricted in the main hole by the buckle ring and the inner flange, so that the ratchet is capable of rotating along the wall of the main hole.

18. The micro-action ratchet wrench, as recited in claim 2, wherein the wrench comprises a buckle groove arranged on the main hole for installing a buckle ring, and an inner flange arranged on the main hole and necked down the diameter thereof, wherein the ratchet is restricted in the main hole by the buckle ring and the inner flange, so that the ratchet is capable of rotating along the wall of the main hole.

19. The micro-action ratchet wrench, as recited in claim 3, wherein the wrench comprises a buckle groove arranged on the main hole for installing a buckle ring, and an inner flange arranged on the main hole and necked down the diameter thereof, wherein the ratchet is restricted in the main hole by the buckle ring and the inner flange, so that the ratchet is capable of rotating along the wall of the main hole.

20. The micro-action ratchet wrench, as recited in claim 4, wherein the wrench comprises a buckle groove arranged on the main hole for installing a buckle ring, and an inner flange arranged on the main hole and necked down the diameter thereof, wherein the ratchet is restricted in the main hole by the buckle ring and the inner flange, so that the ratchet is capable of rotating along the wall of the main hole.
